(19) United States
(12) Patent Application Publication
(10) Pub. No.: US 2009/0121631 A1
(43) Pub. Date: May 14, 2009

(54) Plasma display panel and production method therefor

(76) Inventors: Masahiro Sawa, Miyazaki (JP); Koji Ohira, Miyazaki (JP)

Correspondence Address: MCDERMOTT WILL & EMERY LLP, 600 13TH STREET, N.W., WASHINGTON, DC, 20005-3096, US

(21) Appl. No.: 11/988,890

(22) PCT Filed: Aug. 26, 2005
(86) PCT No.: PCT/JP2005/015548

§ 371 Date: Jan. 16, 2008

(51) Int. Cl. H01J 17/49; H01J 9/26

(52) U.S. Cl. 313/582; 445/25

(57) ABSTRACT

A plasma display panel production method is provided for producing a plasma display panel including a first substrate, a second substrate opposed to the first substrate, a barrier rib partitioning a space defined between the first and second substrates into a plurality of discharge spaces, and a seal frit portion provided between peripheral inner surface portions of the first and second substrates to seal the first and second substrates. The method comprises the steps of: forming a seal frit portion on one of the first and second substrates, and forming a barrier rib on the second substrate; combining the first substrate and the second substrate with a spacer of the same material as the seal frit portion being provided between the first substrate and a top of the barrier rib; pressing peripheral portions of the first and the second substrates from outside by a pressing member; heating the first and second substrates to a temperature not lower than a softening temperature of the seal frit portion while evacuating the space defined between the first and second substrates; and introducing a discharge gas into the space defined between the first and second substrates after the evacuating step.

### TECHNICAL FIELD

The present invention relates to a plasma display panel and a production method therefor and, particularly, to a plasma display panel (hereinafter referred to as “PDP”) for use as a display device for a personal computer, a work station or the like, a flat TV, a display for displaying advertisement and other information.

### BACKGROUND ART

PDPs generally commercialized at present are of an AC surface discharge type. The surface discharge type is such that first and second display electrodes respectively serving as negative electrodes and positive electrodes are arranged parallel to each other in a plane on a front substrate or on a rear substrate for primary discharge for display. In a PDP of the surface discharge type, fluorescent layers for full-color display are provided apart from the display electrode pairs with respect to the thickness of the panel, so that deterioration of the fluorescent layers can be suppressed which may otherwise occur due to ion bombardment during the discharge. Therefore, the surface discharge type PDP has a longer service live as compared with a PDP of an opposed discharge type in which first display electrodes and second display electrodes are respectively provided on a front substrate and a rear substrate in opposed relation.

An electrode matrix structure for the surface discharge type is a so-called tri-electrode structure which typically includes display electrode pairs and address electrodes disposed in crossing relation to the display electrode pairs for cell addressing. A basic form of the tri-electrode structure is such that the display electrode pairs are respectively disposed on display lines of a display screen. A distance (surface discharge gap) between display electrodes of each display electrode pair on a display line is about several tens μm to about a hundred and several tens μm, and the discharge occurs at a voltage of about 200 V to about 250 V. On the other hand, a distance (reverse slit) between two adjacent display electrode pairs is sufficiently greater than the surface discharge gap for prevention of surface discharge between the two adjacent display electrode pairs. In this case, the reverse slit provides a non-light-emission region. Therefore, the utilization factor of the display screen is reduced as the area of the non-light-emission region increases.

Another form of the tri-electrode structure is such that display electrodes are equidistantly arranged and the surface discharge is caused between every adjacent pair of electrodes. In this case, discharge slits and reverse slits have the same width, making it difficult to drive the PDP by a driving method employed for driving the PDP of the basic-form tri-electrode structure in which the reverse slits each have a greater width than the discharge slits. Therefore, an interlace driving method is employed in which an odd-line display electrode and an even-line display electrode in each field are alternately caused to discharge so that light emitted by the discharge from a single display line reaches adjacent reverse slits for the display. This method increases the light emission utilization factor, because the reverse slits otherwise serving as non-light-emission regions also serve as light emission regions. Therefore, the PDP driven by this method is highly bright and highly efficient. However, this method requires a complicated driving sequence for the addressing for the display, and the display electrodes are vertically arranged close to each other (in a column direction) in the absence of the reverse slits. Therefore, discharge interference (crosstalk) is liable to occur between display cells arranged adjacent each other in the column direction.

An exemplary method for increasing the display screen utilization factor and preventing the discharge interference between the display cells arranged adjacent each other in the column direction in the tri-electrode structure is such that barrier ribs are provided parallel to each other on the second substrate (rear substrate) as extending along the display lines (laterally), and respectively superposed on elongated electrically conductive power supply films equidistantly arranged on the display electrodes or bus electrodes on the first substrate (front substrate) as continuously extending along the entire lengths of the display lines. In such a structure, a unit light emitting region (each cell) is defined as a box-shaped space surrounded by barrier ribs (box cell structure). In this case, the light emission efficiency is increased by about 1.2 times because a light emission fluorescent area per cell is increased. This is because the cell structure including the bus electrodes superposed on the lateral barrier ribs efficiently utilizes the light emitted from the fluorescent layers without obstruction of the light by the bus electrodes in the light emission region. However, this requires that the lateral barrier ribs each have a greater width than the bus electrodes, and are highly accurately positioned with respect to the bus electrodes (the front substrate is accurately positioned with respect to the rear substrate). In practice, the lateral barrier rib width is greater by several tens μm than the bus electrode width in consideration of a positioning offset. Further, the lateral barrier ribs physically prevent vertical transfer of electric charges (in the column direction), thereby preventing the vertical discharge interference.

Meanwhile, the electrical characteristics of the panel are significantly influenced by evacuation efficiency in a panel sealing/evacuating step of a PDP production process. More specifically, insufficient removal of impurities from the panel during the evacuation is liable to result in reduction in brightness due to deterioration of the fluorescent layers, fluctuation in discharge voltage and uneven light emission in the plane of the panel due to the fluctuation in discharge voltage. In particular, a center portion of the panel has a smaller evacuation conductance, making it difficult to remove the impurities. As the PDP tends to have a greater panel size and a higher definition, the removal of the impurities will be increasingly insufficient. In addition, the PDP of the box cell structure which ensures a higher light emission efficiency naturally has a smaller evacuation conductance than the PDP having a simple striped barrier rib structure. This makes it generally difficult to provide a wider evacuation path. In order to provide a high-definition and high-quality PDP, it is essential to increase the evacuation conductance to increase the evacuation efficiency.

On the other hand, a method for providing a sufficient evacuation path during the evacuation is known in which spacers are provided on the lateral barrier ribs on the rear substrate to increase a gap defined between the front substrate and the rear substrate (see, for example, Patent Document 1). In this case, spacers composed of a material having a softening temperature higher than a frit sealing temperature are provided between the barrier ribs and the front substrate. Then, the resulting panel is heated to a temperature not lower than the seal frit softening temperature and not higher than the spacer softening temperature to soften a seal frit while being evacuated. After completion of the evacuation, the panel is heated to a temperature not lower than the spacer softening temperature to melt the spacers to close gaps between the front substrate and the barrier ribs.
Patent Document 1: JP-A1-2002-260537

### DISCLOSURE OF THE INVENTION

### Problems to be Solved by the Invention

However, the prior art methods are problematic in that a new material for the spacers having a higher softening temperature than the seal frit is additionally required and, in some cases, an evacuation pressure profile and a temperature profile should be changed.

### Means for Solving the Problems

The present invention provides a plasma display panel production method for producing a plasma display panel including a first substrate, a second substrate opposed to the first substrate, a barrier rib partitioning a space defined between the first and second substrates into a plurality of discharge spaces, and a seal frit portion provided between peripheral inner surface portions of the first and second substrates to seal the first and second substrates, the method comprising the steps of: forming a seal frit portion on one of the first and second substrates, and forming a barrier rib on the second substrate; combining the first substrate and the second substrate with a spacer of the same material as the seal frit portion being provided between the first substrate and a top of the barrier rib; pressing peripheral portions of the first and the second substrates from outside by a pressing member; heating the first and second substrates to a temperature not lower than a softening temperature of the seal frit portion while evacuating the space defined between the first and second substrates; and introducing a discharge gas into the space defined between the first and second substrates after the evacuating step.

The barrier rib may include a row barrier rib extending in a row direction and a column barrier rib extending in a column direction.

The first substrate preferably includes a transparent electrode and a bus electrode each extending in the row direction, and the bus electrode is preferably superposed on the row barrier rib with the first and second substrates being combined.

The spacer may be formed in an elongated shape on the barrier rib so as to be superposed on the bus electrode with the first and second substrates being combined.

The spacer preferably has a smaller width than the bus electrode after having been cured after the evacuation step.

The spacer may be discontinuous in the step of combining the first and second substrates, and continuous after the evacuating step.

The spacer may have a gap at an intersection of the row barrier rib and the column barrier rib in the step of combining the first and second substrates.

The spacer may have a gap at a position intermediate between intersections of the row barrier rib and column barrier ribs.

The pressing member preferably includes a plurality of clips, and the clips preferably each include a resilient member which resiliently clamps the first and second substrates.

The present invention further provides a plasma display panel produced by the abovementioned method.

According to another aspect of the present invention, there is provided a plasma display panel, which comprises: a first substrate; a second substrate opposed to the first substrate; a barrier rib partitioning a space defined between the first and second substrates into a plurality of discharge spaces; a seal frit portion provided between peripheral portions of the first and second substrates to seal the first and second substrates; and a spacer inserted between the barrier rib and the second substrate; wherein the spacer is composed of the same material as the seal frit portion.

### Effects of the Invention

According to the present invention, the spacer composed of the same material as the seal frit portion is employed, and a peripheral portion of the panel is pressed from the outside. Therefore, a portion of the spacer located in the peripheral portion of the panel and a portion of the spacer located in a center portion of the panel are contracted in a time staggered manner, so that the center portion of the panel can be evacuated even after the portion of the spacer located in the peripheral portion is contracted. Thus, the inside of the panel can be sufficiently evacuated. This obviates the need for additionally providing the new material and changing the temperature profile and the evacuation pressure profile.

### BRIEF DESCRIPTION OF THE DRAWINGS

FIG. 1 is an exploded perspective view of a plasma display panel according to the present invention.

FIG. 2 is a diagram for explaining the layout of barrier ribs and electrodes according to an embodiment of the present invention.

FIG. 3 is a flow chart showing a production process according to the embodiment of the invention.

FIG. 4 is a diagram for explaining the layout of the barrier ribs and spacers according to the embodiment of the invention.

FIG. 5 is a diagram for explaining the layout of the barrier ribs and spacers according to the embodiment of the invention.

FIG. 6 is a diagram for explaining the layout of the barrier ribs and spacers according to the embodiment of the invention.

FIG. 7 is a diagram for explaining the layout of the barrier ribs and spacers according to the embodiment of the invention.

FIG. 8 is a diagram for explaining the layout of the barrier ribs and spacers according to the embodiment of the invention.

FIG. 9 is a characteristic diagram showing a change in the size of the spacer in the embodiment of the invention.

FIGS. 10(a) to 10(d) are diagrams for explaining a sealing/evacuating step in the embodiment of the invention.

FIG. 11 is a diagram for explaining clip fixing positions in the embodiment of the invention.

FIG. 12 illustrates an evacuation pressure profile and a temperature profile in the embodiment of the invention.

FIG. 13 is a diagram for explaining the composition of a seal frit in the embodiment of the invention.

FIG. 14 is a plan view of a clip in the embodiment of the invention.

FIG. 15 is a side view of the clip in the embodiment of the invention.

### DESCRIPTION OF REFERENCE CHARACTERS

1: Substrate
2: Substrate
3: Transparent electrodes
4: Bus electrodes
11: Dielectric layer
12: Protective film
13: Address electrodes
14: Dielectric layer
15: Barrier ribs
16: Fluorescent layers
17: Fluorescent layers
18: Fluorescent layers
19: Barrier ribs
20: Spacers
21: Clips
22: Seal frit portion
100: PDP

### BEST MODE FOR CARRYING OUT THE INVENTION

The present invention will hereinafter be described in detail based on an embodiment thereof illustrated in the attached drawings.

Construction of PDP

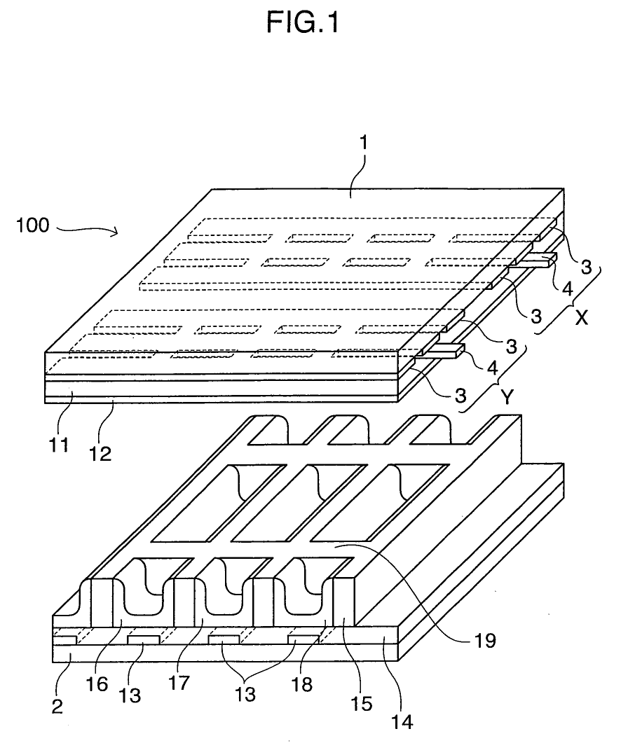

FIG. 1 is an exploded perspective view illustrating major portions of a PDP of a box cell structure to which the inventive production method is applied. The PDP 100 shown in FIG. 1 is a PDP of an AC tri-electrode surface discharge structure for full-color display, and generally includes a plurality of display electrodes disposed between a pair of substrates, and a plurality of address electrodes crossing the display electrodes.

More specifically, the PDP 100 includes a front panel assembly including a front substrate 1, and a rear panel assembly including a rear substrate 2. The front substrate 1 and the rear substrate 2 are each formed of a glass plate having a thickness of 2 to 3 mm.

A plurality of display electrodes X, Y are equidistantly arranged in a column direction on an inner surface of the front substrate 1 as extending in a row direction. These display electrodes X, Y are configured such that surface discharge is caused between a display electrode X (also referred to as X-electrode) and a display electrode Y (also referred to as Y-electrode) of each adjacent display electrode pair for display. The surface discharge is utilized for the display and, therefore, generally referred to as display discharge. Further, the surface discharge is utilized for sustaining light emission and, therefore, also referred to as sustain discharge. In this sense, the display electrodes are also referred to as sustain electrodes.

The display electrodes X, Y each include a transparent electrode 3 such as of ITO or SnO₂ having a greater width and a bus electrode (opaque electrode) 4 of a metal such as Ag, Au, Al, Cu, Cr or a laminate of any of these metals (e.g., a Cr/Cu/Cr laminate) having a smaller width and serving for reduction of electrode resistance. Desired numbers of display electrodes X, Y are formed of Ag or Au by a printing method, or formed of any of the other of the aforementioned metals by employing a film formation method such as an evaporation method or a sputtering method and an etching method in combination, as each having a desired thickness, a desired width and a desired pitch. The display electrodes Y serve as scanning electrodes for addressing.

The transparent electrode 3 shown in FIG. 1 is of a ladder shape, each including three strip-shaped electrode portions extending parallel to each other, and electrode portions which connect the three strip-shaped electrode portions at a predetermined pitch in a column direction. The bus electrode 4 is superposed on a middle one of the three strip-shaped electrode portions of the transparent electrode 3.

A dielectric layer 11 covers the transparent electrodes 3 and the bus electrodes 4. The dielectric layer 11 is formed as having a thickness of several tens μm, for example, by applying a glass paste prepared by adding a binder and a solvent to a low melting point glass frit on the front substrate 1 by a screen printing method, and firing the resulting substrate.

A protective film 12 is provided on the dielectric layer 11 for protecting the dielectric layer 11 from a damage which may otherwise occur due to ion bombardment when the discharge is caused for the display. The protective film 12 has a thickness of about 1 μm, and is composed of, for example, MgO, CaO, SrO, BaO or the like.

A plurality of address electrodes 13 are provided on an inner surface of the rear substrate 2 as extending perpendicularly to the display electrodes X, Y in the column direction. The address electrodes 13 are adapted to cause address discharge at intersections of the scanning display electrodes and the address electrodes 13, and each composed of, for example, Ag, Au, Al, Cu, Cr or a laminate of any of these metals (e.g., a Cr/Cu/Cr laminate). Like the display electrodes X, Y, a desired number of address electrodes 13 are formed of Ag or Au by a printing method, or formed of any of the other of the aforementioned metals by employing a film formation method such as an evaporation method or a sputtering method and an etching method in combination, as each having a desired thickness, a desired width and a desired pitch.

A dielectric layer 14 formed of the same material by the same method as the dielectric layer 11 covers the address electrodes 13.

Row barrier ribs 19 and column barrier ribs 15 formed by a sandblast method, a printing method, a photo-etching method or the like are provided on the dielectric layer 14. The formation of the barrier ribs 15, 19 is achieved by applying a glass paste containing a low melting point glass frit, a binder, a solvent and the like on the dielectric layer 14, drying the glass paste, cutting the resulting glass paste layer by a sandblast method, and firing the resulting glass paste layer. Alternatively, a photosensitive resin may be employed as the binder, and the formation of the barrier ribs 15, 19 may be achieved by light exposure with a mask, development and firing. The barrier ribs 15, 19 thus formed each have a height of about 100 to about 200 μm.

Fluorescent layers 16, 17, 18 which are formed by applying a fluorescent paste containing fluorescent powder and a binder by a screen printing method or by means of a dispenser, repeating the fluorescent paste application for respective colors and firing the resulting fluorescent paste layers are provided in box-shaped regions defined by the barrier ribs 15, 19. Alternatively, the formation of the fluorescent layers 16, 17, 18 may be achieved by a photolithography method employing sheets of fluorescent layer materials (so-called green sheets) each containing fluorescent powder and a binder. In this case, a sheet for a desired color is applied on the entire display region on the substrate 2, and subjected to light exposure and development. This process is repeated for the respective colors, whereby the respective color fluorescent layers are formed between corresponding barrier ribs.

The rear substrate 2 has a vent hole (not shown) for evacuating the inside of the panel and filling a discharge gas, and a gas supply pipe (not shown) is connected to the vent hole.

The PDP 100 is produced by positioning the front panel assembly and the rear panel assembly in opposed relation with the display electrodes X, Y extending perpendicularly to the address electrodes 13, sealing a peripheral portion of the resulting panel with a seal frit, degassing spaces defined by the barrier ribs 15, 19, and filling the spaces with a discharge gas such as a gas mixture of neon and xenon. In the PDP 100, discharge spaces (box cells) in which the display electrodes X, Y overlap with the address electrodes 13 are each defined as a cell region (unit light emission region) which is a minimum display unit.

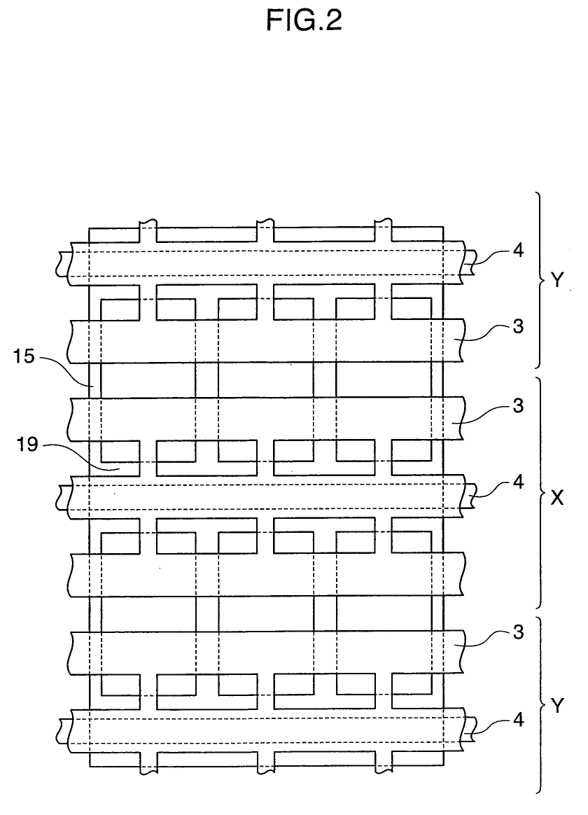

FIG. 2 is a diagram for explaining the layout of the column barrier ribs 15, the row barrier ribs 19, the transparent electrodes 3 and the bus electrodes 4. As shown in FIG. 2, the middle electrode portions of the transparent electrodes 3 are located on the row barrier ribs 19, and the bus electrodes (opaque electrodes) 4 are superposed on the middle electrode portions. Thus, a so-called “common bus electrode structure” is provided, whereby the light emission efficiency is improved without obstruction of light by the bus electrodes 4 in the light emission regions.

Production Method

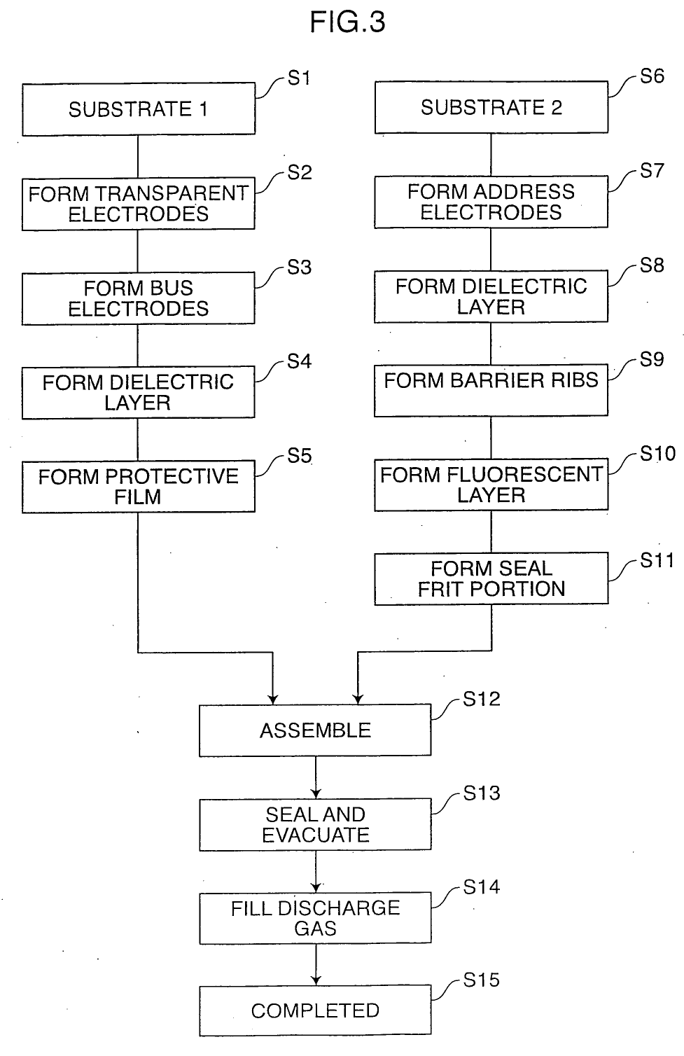

Next, a production process for the PDP 100 shown in FIG. 1 will be described with reference to a flow chart shown in FIG. 3.

In a front panel assembly preparing process (Steps S1 to S5), a glass substrate having a thickness of 2 to 3 mm is prepared as the substrate 1 (Step S1), and an ITO film is formed on a surface of the substrate 1 and patterned by employing the evaporation method or the sputtering method and the etching method in combination, whereby the transparent electrodes 3 are formed on the surface of the substrate 1 (Step S2).

Subsequently, the metal bus electrodes 4 are formed on the middle electrode portions of the transparent electrodes 3 by the printing method (Step S3). Then, the dielectric layer 11 and the protective film 12 are formed on the resulting substrate (Steps S4 and S5). Thus, the front panel assembly is completed.

In a rear panel assembly preparing process (Steps S6 to S11), on the other hand, a glass substrate having a thickness of 2 to 3 mm is prepared as the substrate 2 (Step S6), and the metal address electrodes 13 are formed on a surface of the substrate 2 by the printing method (Step S7). Then, the dielectric layer 14 is formed on the resulting substrate (Step S8). Further, the column barrier ribs 15 and the row barrier ribs 19 are formed on the resulting substrate as having the same height, and the fluorescent layers 16 to 18 are formed on the resulting substrate (Steps S9 and S10).

In turn, a seal frit material is applied on a peripheral portion of the surface of the substrate 2 and on top portions of the row barrier ribs 19 by the printing method, and fired. Thus, the seal frit portion is formed on the peripheral portion of the substrate 2, and the spacers are formed on the top portions of the barrier ribs 19 (Step S11).

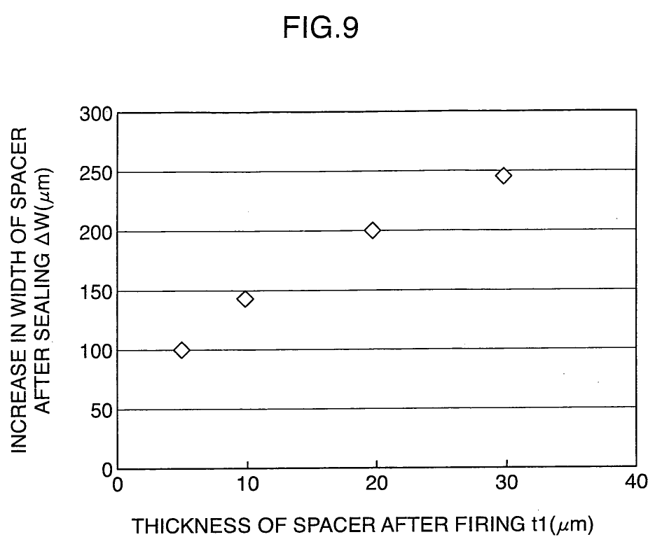

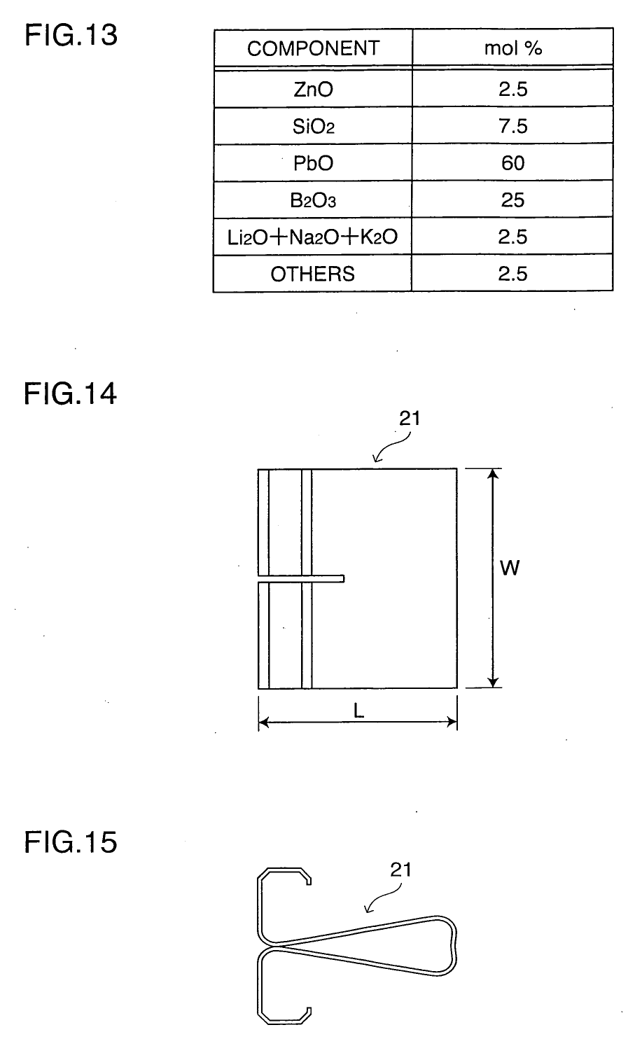

A material having a composition shown in FIG. 13 is employed as the seal frit material. The seal frit material has a softening temperature of 410° C. If the seal frit material is applied to a thickness t0, the thickness of the seal frit material is reduced to t1=0.6·t0 after the firing. As will be described later, the spacers are each pressed to have an increased width after the substrates 1, 2 are combined and sealed. An increase ΔW in spacer width increases with the thickness t1 as shown in FIG. 9.

Therefore, in consideration of the above relationship, the application width of the seal frit material for the spacers is determined so that the spacer width is smaller than the width of the row barrier ribs 19, preferably smaller than the width of the bus electrodes 4, after the sealing of the substrates 1, 2.

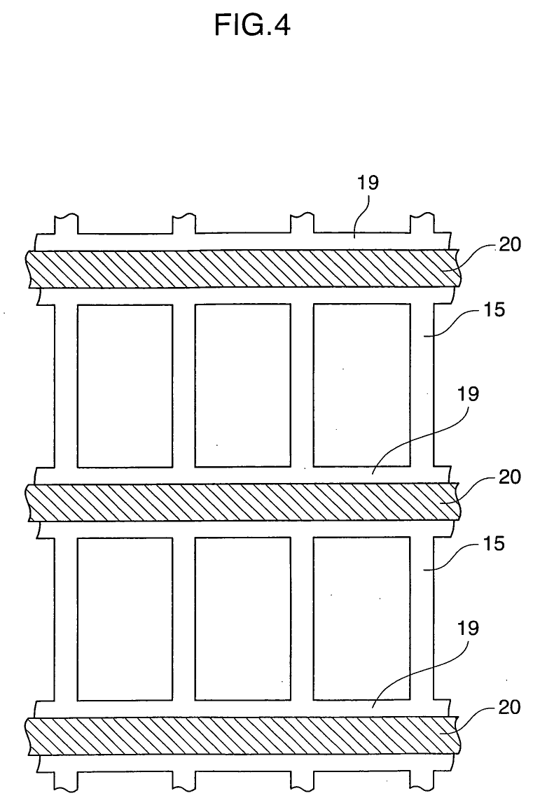

FIGS. 4 to 8 illustrate various forms of the spacers 20 formed on the top portions of the barrier ribs 19 after the firing. In FIG. 4, strip-shaped spacers 20 respectively extend along the row barrier ribs 19. In an assembling step and an evacuating step to be described later, gaps equivalent to the thickness of the spacers 20 are formed between the substrates 1 and 2 as extending in the row direction before the sealing. The gaps provide evacuation paths with respect to the row direction, permitting efficient evacuation.

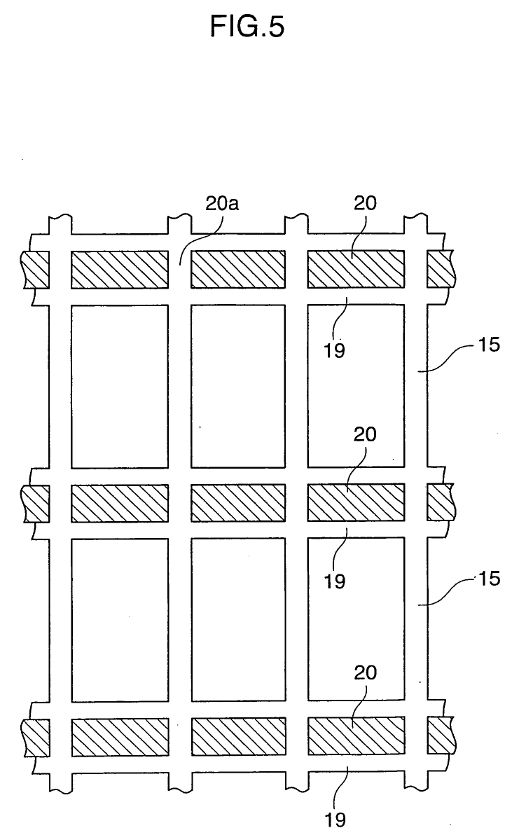

Spacers 20 shown in FIG. 5 each have gaps 20a extending across the row barrier rib 19 at the intersections of the column barrier ribs 15 and the row barrier rib 19. Therefore, the spacers 20 provide evacuation paths with respect to the row direction and the column direction, permitting more efficient evacuation.

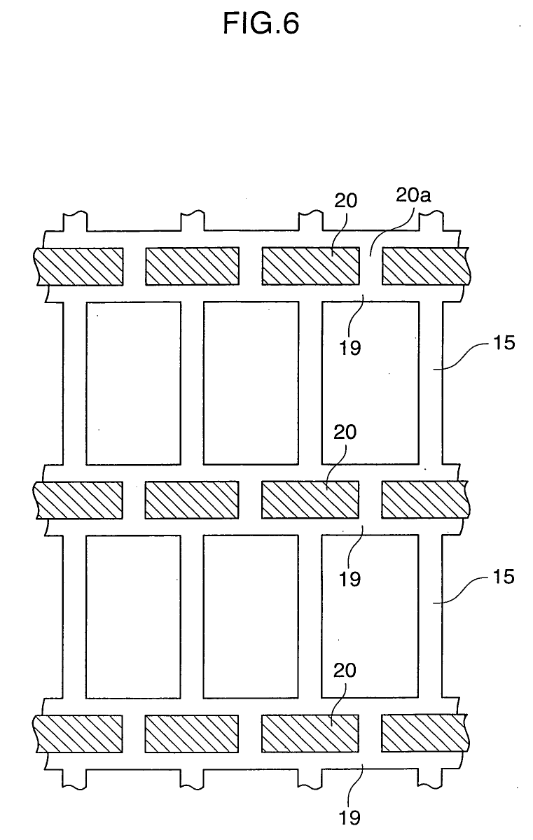

Spacers 20 shown in FIG. 6 each have gaps 20a extending across the row barrier rib 19 at positions intermediate between adjacent intersections of the column barrier ribs 15 and the row barrier rib 19. Therefore, like the spacers shown in FIG. 5, the spacers 20 provide evacuation paths with respect to the row direction and the column direction, permitting more efficient evacuation.

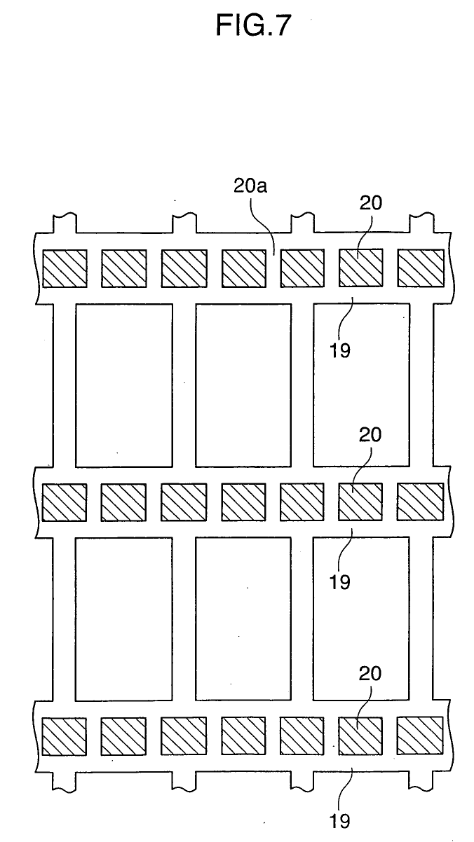

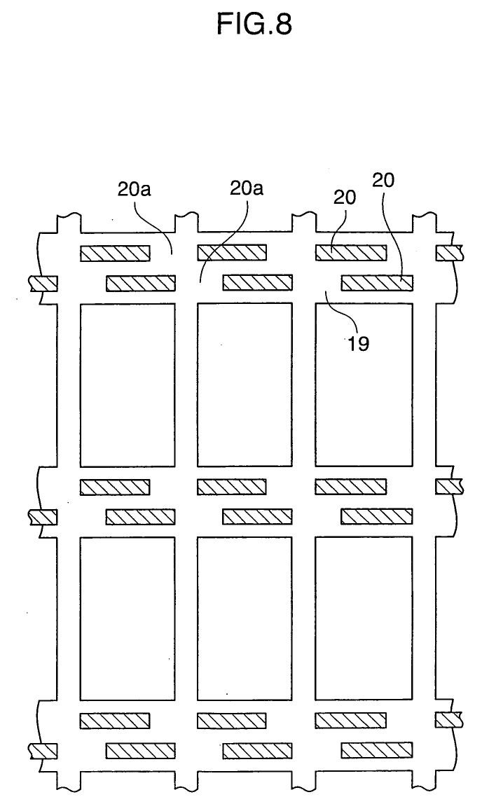

Spacers 20 shown in FIGS. 7 and 8 each have a greater number of gaps 20a, thereby permitting further more efficient evacuation. When the spacers 20 shown in any of FIGS. 5 to 8 are melted in a sealing step to be described later, the gaps 20a of the spacers 20 are filled with the melted spacer material and hence eliminated.

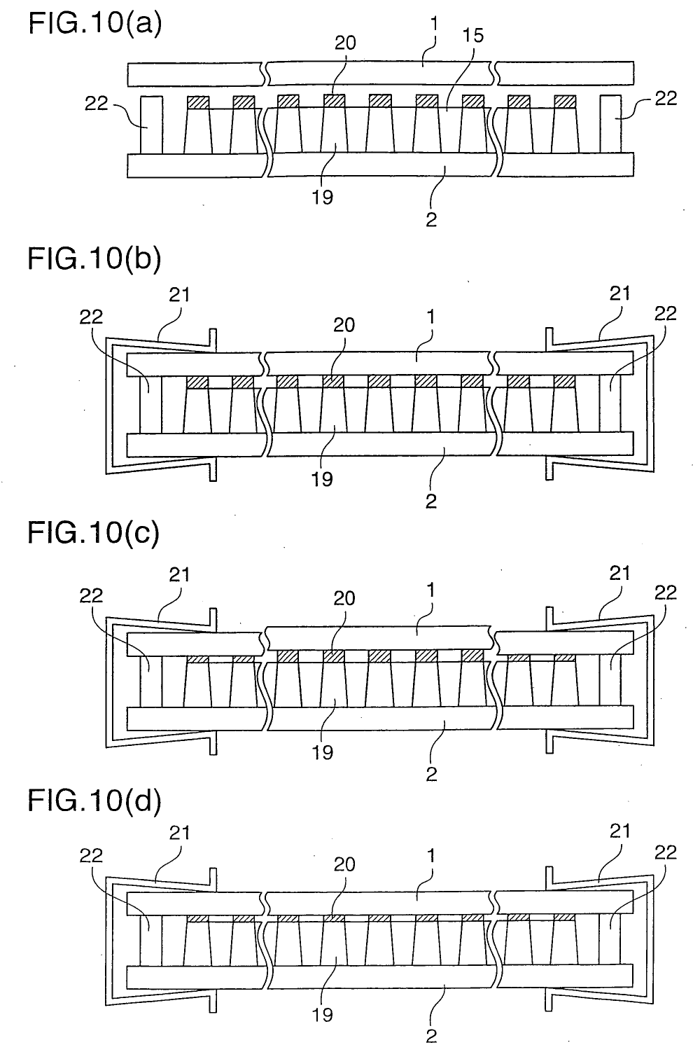

Next, the assembling step (Step S12) and the sealing/evacuating step (Step S13) shown in FIG. 3 will be described in detail with reference to FIGS. 10 to 12.

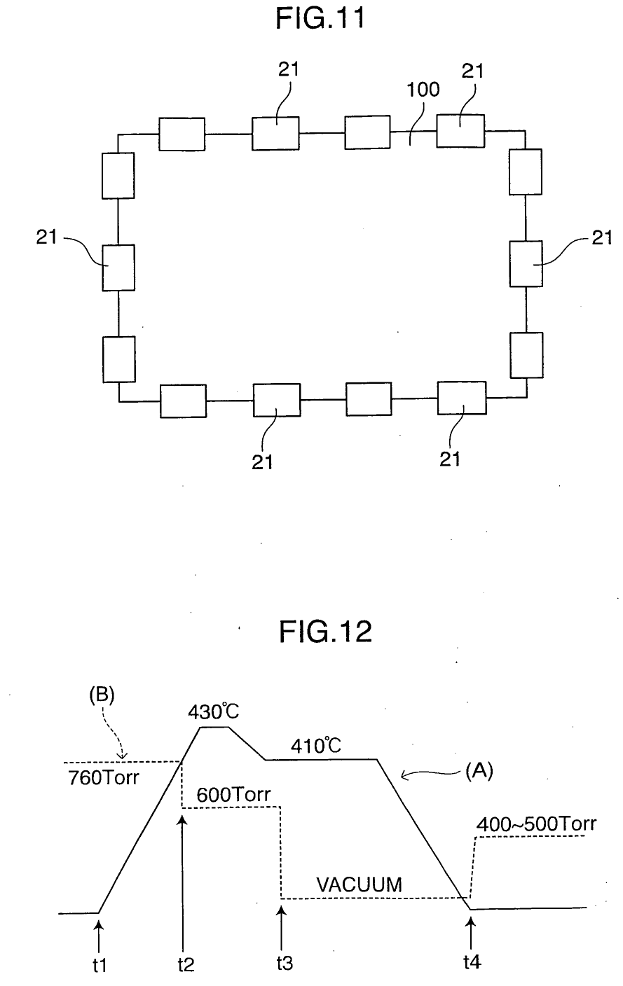

FIGS. 10(a) to 10(d) are process diagrams showing the step of sealing the substrates 1 and 2, and FIG. 11 is a top plan view of the PDP panel. FIG. 12 illustrates a temperature profile (A) and an evacuation pressure profile (B) in the sealing step.

The substrate 1 subjected to Steps S1 to S5 in FIG. 3 and the substrate 2 subjected to Step 6 to Step S11 in FIG. 3 are combined in Step S12 as shown in FIG. 10(a). The seal frit portion 22 has been formed on the peripheral portion of the substrate 2, and the spacers 20 have been formed on the row barrier ribs 19.

Then, as shown in FIG. 11, a peripheral portion of the panel 100 obtained by assembling the substrates 1 and 2 is clamped by a plurality of press members, i.e., clips 21, so that the peripheral portions of the substrates 1, 2 are pressed from the outside as shown in FIG. 10(b).

Subsequently, the heating and the evacuation of the panel in the state shown in FIG. 10(b) are simultaneously started at time t1 shown in FIG. 12. The panel is heated from the time t1 to time t2, whereby the seal frit portion 22 and the spacers 20 start softening. At this time, the peripheral portion of the panel is depressed to a greater depth than the center portion of the panel by pressures of the clips 21 as shown in FIG. 10(c). However, the center portion is efficiently evacuated through evacuation paths established in the center portion, so that the vacuum degree starts increasing as shown in FIG. 12. If the panel is evacuated to high vacuum immediately after the time t2, leakage is liable to occur. Therefore, the panel is maintained in lower vacuum (600 Torr) for a while, until the peripheral portion is sufficiently sealed at an increased temperature, and the temperature is slightly reduced from a peak level (430° C.) for preliminary evacuation. Then, primary evacuation is started at time t3 at which the sealed peripheral portion is stabilized. At this time, the evacuation paths are still sufficiently established in the center portion to ensure a high evacuation conductance, so that the panel is efficiently evacuated. With the panel sufficiently evacuated, the internal pressure of the panel is much lower than the atmospheric pressure, so that the center portion of the panel is also depressed as shown in FIG. 10(d). Thus, the substrate 1 is brought into a flat state.

After the temperature is reduced, the melted spacers 20 and the melted seal frit portion 22 are cured. Thus, the sealing/evacuating step (Step S13) is completed.

Then, in Step S14 shown in FIG. 3, the discharge gas (rare gas) is filled in the panel at time t4 (FIG. 12) at which the temperature is reduced to an ordinary temperature. Thus, the panel 100 is completed (Step S15).

FIGS. 14 and 15 are a plan view and a side view, respectively, of the clip 21. In this embodiment, the clips 21 each have a width W of 63 mm, a length L of 55 mm and a thickness of 0.8 mm, and are composed of a heat-resistant resilient alloy. For a 42V-type PDP panel 100 (994 mm×585 mm), for example, 14 such clips are employed for clamping and pressing a peripheral portion of the panel.

### INDUSTRIAL APPLICABILITY

In the inventive production method, a plasma display panel of a box cell structure is efficiently evacuated. Therefore, the inventive production method is applicable to the production of a high-definition and high-quality plasma display panel.

What is claimed is:

1. A plasma display panel production method for producing a plasma display panel including a first substrate, a second substrate opposed to the first substrate, a barrier rib partitioning a space defined between the first and second substrates into a plurality of discharge spaces, and a seal frit portion provided between peripheral inner surface portions of the first and second substrates to seal the first and second substrates, the method comprising the steps of:
forming a seal frit portion on one of the first and second substrates, and forming a barrier rib on the second substrate;
combining the first substrate and the second substrate with a spacer of the same material as the seal frit portion being provided between the first substrate and a top of the barrier rib;
pressing peripheral portions of the first and the second substrates from outside by a pressing member;
heating the first and second substrates to a temperature not lower than a softening temperature of the seal frit portion while evacuating the space defined between the first and second substrates; and
introducing a discharge gas into the space defined between the first and second substrates after the evacuating step.

2. A method as set forth in claim 1, wherein the barrier rib includes a row barrier rib extending in a row direction and a column barrier rib extending in a column direction.

3. A method as set forth in claim 2, wherein the first substrate includes a transparent electrode and a bus electrode each extending in the row direction, and the bus electrode is superposed on the row barrier rib with the first and second substrates being combined.

4. A method as set forth in claim 3, wherein the spacer is formed in an elongated shape on the barrier rib so as to be superposed on the bus electrode with the first and second substrates being combined.

5. A method as set forth in claim 4, wherein the spacer has a smaller width than the bus electrode after having been cured after the evacuation step.

6. A method as set forth in claim 4, wherein the spacer is discontinuous in the step of combining the first and second substrates, and is continuous after the evacuating step.

7. A method as set forth in claim 4, wherein the spacer has a gap at an intersection of the row barrier rib and the column barrier rib in the step of combining the first and second substrates.

8. A method as set forth in claim 4, wherein the spacer has a gap at a position intermediate between adjacent intersections of the row barrier rib and column barrier ribs.

9. A method as set forth in claim 1, wherein the pressing member includes a plurality of clips, and the clips each include a resilient member which resiliently clamps the first and second substrates.

10. A plasma display panel produced by a method as recited any one of claims 1 to 9.

11. A plasma display panel comprising:
a first substrate;
a second substrate opposed to the first substrate;
a barrier rib formed on the first substrate, the barrier rib partitioning a space defined between the first and second substrates into a plurality of discharge spaces;
a seal frit portion provided between peripheral portions of the first and second substrates to seal the first and second substrates; and
a spacer inserted between the barrier rib and the second substrate;
wherein the spacer is composed of the same material as the seal frit portion.
